(19) United States
(12) Patent Application Publication
(10) Pub. No.: US 2026/0208135 A1
(43) Pub. Date: Jul. 23, 2026

(54) SYSTEMS FOR OXYFUEL COMBUSTION FURNACES WITH HEAT RECAPTURE AND REDUCED RECIRCULATION OF FLUE GAS

(71) Applicant: SABIC GLOBAL TECHNOLOGIES B.V., BERGEN OP ZOOM (NL)

(72) Inventors: Arno Johannes Maria OPRINS, Bangalore (IN); Dirk VOGELS, Bangalore (IN); Leo KOERSVELT, Bangalore (IN); Kenneth Francis LAWSON, Bangalore (IN)

(73) Assignee: SABIC GLOBAL TECHNOLOGIES B.V., BERGEN OP ZOOM (NL)

(21) Appl. No.: 19/141,047

(22) PCT Filed: Dec. 5, 2023
(86) PCT No.: PCT/EP2023/084296

§ 371 Date: Jun. 18, 2025

(30) Foreign Application Priority Data
Dec. 20, 2022 (EP) 22215187.0

(51) Int. Cl. B01J 6/00; B01J 19/00; B01J 19/24

(52) U.S. Cl. CPC B01J 6/008; B01J 19/0013; B01J 19/2415; B01J 2219/00081; B01J 2219/00103; B01J 2219/00157

(57) ABSTRACT

This disclosure includes oxyfuel furnaces for chemical-production processes, as well as systems for steam cracking and other chemical-production processes. Such furnaces utilize oxyfuel burners in the radiant section, and—rather than recirculating all flue gas from outlet of the convection section back to the radiant section—recirculates from the convection section a portion of flue gas that enters the convection section.

### FIELD OF DISCLOSURE

The present disclosure is generally related to processes for producing chemicals and, more particularly but not by way of limitation, to any oxyfuel furnace for chemical-production processes in which flue gas is either not recirculated from the convection section to the radiant section or is recirculated at a reduced rate relative to that of conventional systems, for example at a reduced rate that is insufficient to satisfy the full energy requirements of convection section functions and thereby requires supplemental energy for feed preheating and/or steam generation.

### BACKGROUND

Chemical synthesis plants are utilized to provide a variety of chemicals. Often, a dedicated fuel is burned or combusted to provide heat of reaction for chemical synthesis, energy to heat one or more process streams, energy to vaporize liquids (e.g., boil water used as a diluent), energy to do work (e.g., drive a compressor or pump), or energy for other process operations throughout the chemical synthesis plant. Such burning or combustion of fuels results in the production of flue gases that contain CO₂, which can be harmful to the environment, and also results in a loss of energy efficiency of the process. Likewise, steam is often conventionally utilized as a plant-wide heat and/or energy transfer fluid within chemical synthesis plants. The steam utilized for the heat and/or energy transfer is often produced via the combustion of a fuel, resulting in the production of additional flue gas and further energy efficiency losses during the chemical synthesis. Moreover, the use of steam as source of thermal energy typically results in some losses due to inefficiencies in transferring thermal energy to and from steam, and particularly when using steam to power a turbine to produce electricity.

Some efforts have been made to improve the efficiency of furnaces that burn hydrocarbons. For example, oxyfuel burner configurations have been proposed for the radiant section of a furnace used in chemical production processes.

### SUMMARY

As noted above, oxyfuel burner configurations have been proposed in the radiant section of a furnace used for chemical production processes. Burning of higher concentrations of oxygen leads to smaller amounts of flue gas relative to burning in air because air comprises approximately 78% nitrogen (among other smaller constituents) that is not present in pure oxygen. As a result, no NOₓ combustion byproducts are formed and, instead, the primary combustion byproducts are CO₂ and H₂O, with the CO₂ being much easier to capture/purify from the flue gas given the absence of NOₓ (and other byproducts and constituents that result from air combustion). Additionally, when pure oxygen is used instead for combustion of fuel in the furnace, the absence of nitrogen means that the thermal energy heats a smaller mass of flue gas, such that relatively less fuel can be burned to raise the tube reactor in the radiant section to a sufficient temperature (including reheating recirculated flue gas). However, the smaller mass of flue gas generally results in less power being available from flue gas in the convection section of the furnace.

The following disclosure includes additional improvements to the efficiency of such furnaces. For example, prior proposed configurations for oxyfuel furnaces in steam cracking systems have typically recirculated flue gas at a sufficient rate to satisfy thermal energy needs for preheating the hydrocarbon feedstock and mixture of steam and hydrocarbon feedstock in the convection section of the furnace, as well as for steam superheating, at similar levels as in conventional air-fired furnaces. In addition to steam cracking applications, the present methods and furnaces can be utilized in steam methane reforming and various other applications utilizing hydrocarbon-combustion furnaces having a radiant section and heat recovery (e.g., a convection section), such as are often used for chemical production.

In contrast to prior oxyfuel furnace configurations, the present furnaces and systems either (a) do not recirculate flue gas from the convection section to the radiant section, or (b) recirculate a portion of the flue gas from the convection system to the radiant section at a rate that is insufficient to satisfy the full energy requirements of convection section functions. In some such configurations, the recirculation of flue gas is minimized (depending on whether and where flue gas is recirculated from the convection section) to: (a) reduce the amount of hydrocarbons that must be burned to raise the tube reactor in the radiant section to a sufficient temperature (including reheating recirculated flue gas), thereby reducing the rate of energy consumption for a given process; (b) correspondingly reduce the CO₂ generated by the combustion of hydrocarbons; and reduce the capital costs associated with any required ducting, blowers, and/or air-separation units.

In some configurations of the present furnaces for a chemical-production process, the furnace comprises: a radiant housing defining a radiant section with a gas inlet and a flue gas outlet; one or more oxyfuel burners disposed in the radiant section; a tube reactor disposed in the radiant section; a convection section with a convection inlet, a convection outlet, a convection channel extending from the convection inlet to the convection outlet, and a flue gas bypass disposed between the convection inlet and the convection outlet. In some such configurations, the convection inlet is coupled to the flue gas outlet of the radiant section to receive flue gas from the radiant section; and the flue gas bypass is configured to direct a portion of received flue gas to one of: (i) the gas inlet of the radiant section; or (ii) a heater gas inlet of an oxyfuel flue gas heater that is configured to re-heat recirculated flue gas and convey the reheated flue gas to the convection inlet; or (iii) both (i) and (ii). In some configurations, the convection section includes at least one heat exchanger disposed in the convection channel and configured to transfer thermal energy from the received flue gas to a mixture of steam and hydrocarbon feedstock; and the convection section is configured to: (a) receive thermal energy from a source other than the received flue gas; or (b) direct the mixture of steam and hydrocarbon through an additional heater that receives thermal energy from a source other than the received flue gas; or (c) both (a) and (b).

In certain optional variations of the present furnaces, the at least one heat exchanger comprises a lower mix preheater (LMP).

In certain optional variations of the present furnaces, the at least one heat exchanger comprises a steam superheater (SSH) configured to transfer thermal energy from the received flue gas to steam.

In certain optional variations of the present furnaces, the at least one heat exchanger comprises an upper mix preheater (UMP) configured to transfer thermal energy from the received flue gas to the mixture of steam and hydrocarbon feedstock.

In certain optional variations of the present furnaces, the at least one heat exchanger comprises a feed preheater (FPH) configured to transfer thermal energy from the received flue gas to a hydrocarbon feedstock. In such variations, the flue gas bypass can be disposed between the LMP and the UMP, between the UMP and the FPH, or between the FPH and the convection outlet.

Some configurations of the present steam-cracking systems comprise: one or more of the present furnaces; a transfer line exchanger (TLE); and a UMP steam heat exchanger coupled to the TLE. In some such systems, the radiant section is configured to heat a mixture of steam and hydrocarbon feedstock to a cracking-reaction temperature; the TLE is coupled to an outlet of the tube reactor and configured to quench the heated mixture to a temperature below the cracking-reaction temperature; and the UMP steam heat exchanger is configured to: receive TLE steam from the TLE; receive a mixture of steam and hydrocarbon feedstock from one of the one or more heat exchangers in the convection section; transfer thermal energy from the TLE steam to the mixture; return the mixture to the furnace; and return the TLE steam to the TLE.

Certain of the present systems optionally further comprise: an MPH steam heat exchanger coupled to the TLE and configured to receive TLE steam from the TLE, transfer thermal energy from the TLE steam to the mixture of steam and hydrocarbon feedstock, and return the TLE steam to the TLE; and a conduit coupled to the MPH steam heat exchanger and the UMP steam heat exchanger, the conduit configured to receive steam and mix the received steam with the hydrocarbon feedstock.

Certain of the present systems optionally further comprise: a carbon purification unit (CPU) configured to isolate CO₂ from the flue gas.

Some configurations of the present chemical-production systems comprise: one or more furnaces; and a carbon purification unit (CPU) coupled to the convection outlet, the CPU configured to isolate CO₂ from the flue gas; where the system is configured to direct substantially all flue gas received by the convection section to the CPU. In some such systems, the furnace(s) comprise: a radiant housing defining a radiant section with a gas inlet and a flue gas outlet; one or more oxyfuel burners disposed in the radiant section; a tube reactor disposed in the radiant section; and a convection section with a convection inlet, a convection outlet, and a convection channel extending from the convection inlet to the convection outlet, where the convection inlet is coupled to the flue gas outlet of the radiant section to receive flue gas from the radiant section. In some such systems, the convection section includes one or more heat exchangers disposed in the convection channel and configured to transfer thermal energy from the received flue gas to a hydrocarbon feedstock; the convection section is configured to direct the hydrocarbon feedstock through an additional heater that receives thermal energy from a source other than the received flue gas; and the radiant section is configured to heat the hydrocarbon feedstock to a reaction temperature.

In certain configurations of the present chemical-production systems, the radiant section is configured to heat a mixture of steam and the hydrocarbon feedstock to the reaction temperature, and the system further comprises: a transfer line exchanger (TLE) coupled to an outlet of the tube reactor and configured to quench the heated mixture to a temperature below the cracking-reaction temperature; a UMP steam heat exchanger coupled to the TLE and configured to: receive TLE steam from the TLE; receive a mixture of steam and hydrocarbon feedstock from one of the one or more heat exchangers in the convection section; transfer thermal energy from the TLE steam to the mixture; return the mixture to the furnace; and return the TLE steam to the TLE.

Certain configurations of the present chemical-production systems further comprise: a MPH steam heat exchanger coupled to the TLE; and a conduit coupled to the MPH steam heat exchanger and the UMP steam heat exchanger. In some such systems, the MPH steam heat exchanger is configured to: receive TLE steam from the TLE; receive a hydrocarbon feedstock from one of the one or more heat exchangers in the convection section; transfer thermal energy from the TLE steam to the mixture of steam and hydrocarbon feedstock; return the mixture of steam and hydrocarbon feedstock to the furnace; and return the TLE steam to the TLE. In some such systems, the conduit coupled to the MPH steam heat exchanger and the UMP steam heat exchanger, the conduit configured to: receive the hydrocarbon feedstock from the MPH; receive steam and mix the steam into the hydrocarbon feedstock; and direct the mixture of steam and hydrocarbon feedstock to the UMP steam heat exchanger.

Some of the present chemical-production systems are configured to produce an olefin product and for each ton of the olefin product that is produced, to consume fewer than 12 gigajoules (GJ) of energy and generate fewer than 700 kilograms (kg) of carbon dioxide (CO₂).

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any embodiment of the present apparatuses, kits, and methods, the term “substantially” may be substituted with “within [a percentage] of” what is specified, where the percentage includes 0.1, 1, 5, and/or 10 percent.

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, an apparatus or kit that “comprises,” “has,” “includes” or “contains” one or more elements possesses those one or more elements, but is not limited to possessing only those elements. Likewise, a method that “comprises,” “has,” “includes” or “contains” one or more steps possesses those one or more steps, but is not limited to possessing only those one or more steps.

Further, an apparatus, device or system that is configured in a certain way is configured in at least that way, but it can also be configured in other ways than those specifically described.

Any embodiment of any of the present apparatuses and methods can consist of or consist essentially of—rather than comprise/include/contain/have—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

Details associated with the embodiments described above and others are presented below.

Some details associated with the aspects of the present disclosure are described above, and others are described below. Other implementations, advantages, and features of the present disclosure will become apparent after review of the entire application, including the Brief Description of the Drawings, Detailed Description, and the Claims.

### BRIEF DESCRIPTION OF THE DRAWINGS

The following drawings illustrate by way of example and not limitation. For the sake of brevity and clarity, every feature of a given structure is not always labeled in every figure in which that structure appears. Identical labels or reference numbers do not necessarily indicate an identical structure. Rather, the same reference number may be used to indicate a similar feature or a feature with similar functionality, as may non-identical reference numbers. Dimensioned figures are drawn to scale (unless otherwise noted), meaning the sizes of the depicted elements are accurate relative to each other for at least the embodiment depicted in the figures.

FIG. 1 depicts a block flow diagram of a generalized steam cracking plant or process.

FIG. 2 depicts a schematic diagram of a prior art hydrocarbon steam cracking system.

FIG. 3 depicts a schematic diagram of an example of a convection section of a prior art hydrocarbon steam cracking furnace of the system of FIG. 2.

FIG. 4 depicts a block diagram of a second example of a prior art hydrocarbon steam cracking system with a furnace having a radiant section that utilizes oxyfuel burners.

FIG. 5 depicts a block diagram an example of the present steam cracking furnace systems showing three independent variations of the present configurations.

FIG. 6 depicts a block diagram of a second example of the present steam cracking furnaces for use in a steam cracking system.

FIG. 7 depicts a block diagram of a further example of the present steam cracking furnace systems with a furnace having a radiant section that utilizes oxyfuel burners and a supplemental flue gas heater.

### DETAILED DESCRIPTION

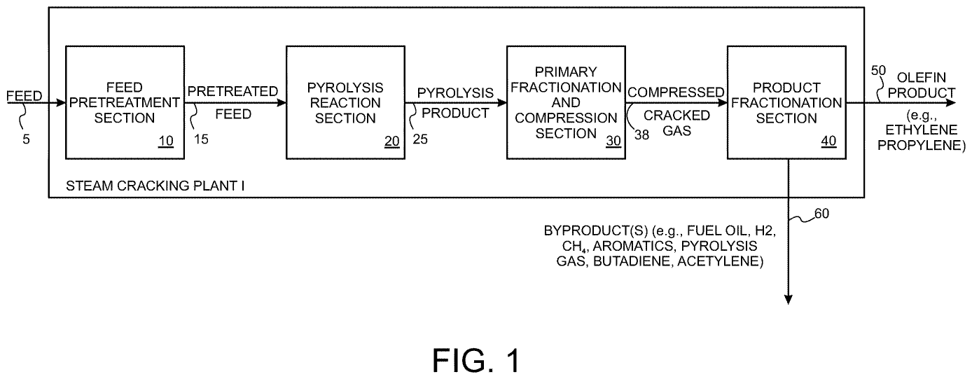

Referring now to the drawings, and more particularly to FIG. 1, shown there is a block flow diagram of an example of a generalized steam cracking plant or process, which includes one or more of the following process sections for converting a feed stream 5 into a desired olefin product stream 50: a feed pretreatment section 10, a pyrolysis reaction section 20, a primary fractionation and compression section 30, a product fractionation (separation) and compression section 40, or a combination thereof. Such sections will be described briefly in the next few paragraphs, and in more detail hereinbelow.

Feed pretreatment section 10 can be configured to adjust the pressure of a feed 5, possibly remove undesirable components (e.g., carbon dioxide (CO₂), mercury, water) from a feed, combine an incoming feed with a stored feed to minimize variations in the feed to the pyrolysis reaction section 20, and/or preheat the feed 5, to provide a pretreated feed stream 15.

Pyrolysis reaction section 20 can comprise at least one steam cracker or ‘pyrolysis’ furnace configured to crack hydrocarbons in the presence of steam to produce a cracked gas stream and a transfer line exchanger (TLE) or other heat transfer device to quench (and optionally harvest heat from) the cracked gas stream to provide a cooled cracked stream 25. Conventionally, the furnaces of a steam cracking plant create a high temperature environment by the combustion of fuels such as methane and hydrogen, which produces carbon dioxide emissions from a conventional steam cracking plant/process. However, in the present embodiments, the furnace is instead a radiative electric furnace in which electric heating elements provide heat or thermal energy in a heating chamber to tubes through which the feed stream flows.

The primary fractionation and compression section 30 can be configured to provide further heat recovery from and quenching of the cooled cracked gas stream 25, remove one or more components (e.g., fuel oil, hydrogen sulfide, carbon dioxide, water, or a combination thereof) from the cracked gas stream 25, and/or compress the cracked gas stream 25, thus providing a compressed cracked gas stream 38.

The product fractionation or separation section 40 can be configured to fractionate the compressed cracked gas stream 38, selectively hydrogenate one or more streams produced during the fractionation, and provide one or more olefin (e.g., ethylene, propylene) product streams 50. The product fractionation or separation section 40 may also provide one or more byproduct streams 60, such as, without limitation, a C₁ stream, a C₂ saturate stream, a C₃ saturate stream, a C₄ saturate stream, an acetylene stream, a butadiene stream, a 1-butene stream, an isobutylene stream, an aromatics stream, a hydrogen stream, a pyrolysis gasoline stream, and/or a fuel oil stream, or streams comprising a combination of these components. Some of these streams may be recycled to one or more sections of the steam cracking plant. For example, without limitation, the C₂, C₃, and/or C₄ saturates streams may be recycled to one or more of the pyrolysis furnaces of the pyrolysis reaction section 20, hydrogen may be purified (e.g., via a pressure swing adsorption unit (PSA) and a methanation reactor to remove CO) and recycled to a hydrogenation reactor (e.g., a C₂, C₃, acetylene, or di-olefin hydrogenator) and/or utilized as a fuel source (e.g., via fuel cell). The C₁ stream may also be recycled for use as a fuel (e.g., for the production of hydrogen therefrom).

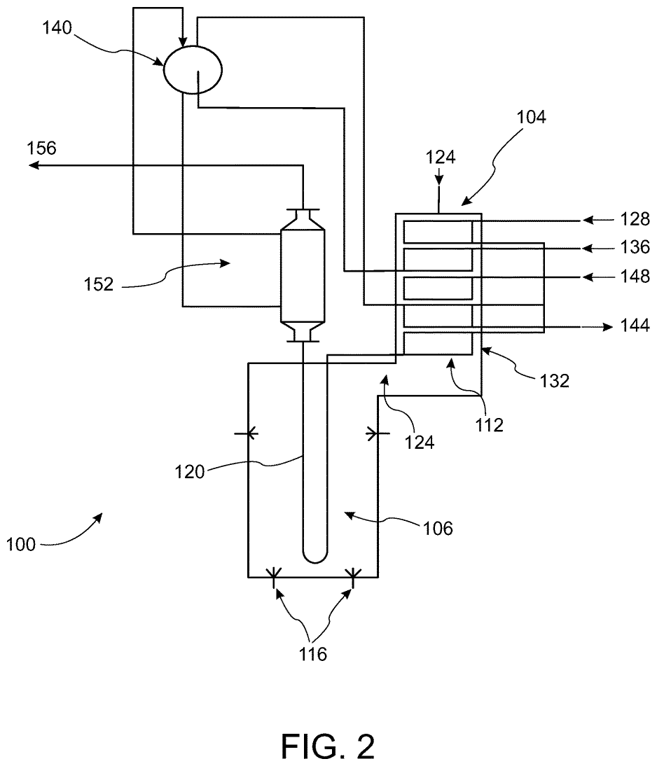

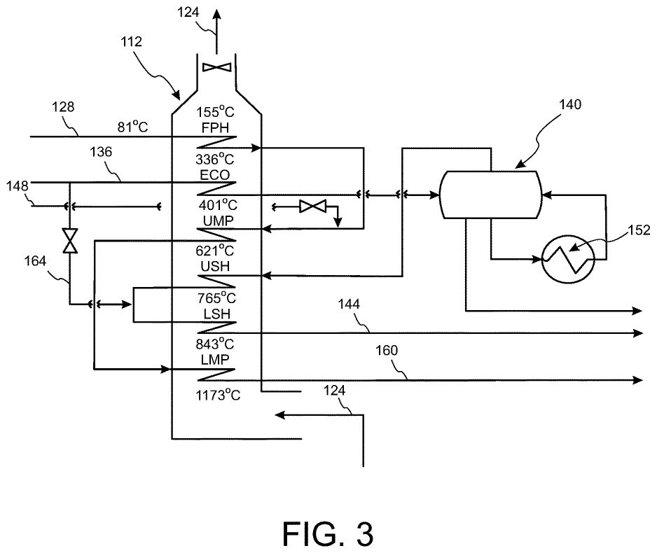

Referring now to FIGS. 2-3, FIG. 2 shows a more-detailed example of a prior art steam cracking furnace system 100 (derived from Ullman, Encyclopedia of industrial chemistry, p. 470 2012 Wiley-VCH Verlag GmbH & Co. KGaA, Weinheim). System 100 comprises a steam cracking furnace 104, having a radiant section 108, and a convection section 112. The radiant section has burners 116 for heating a fired tubular reactor 120 wherein the actual steam cracking of the hydrocarbon feedstock occurs. The flue gas 124 from the burners 116 flows past the fired tubular reactor 120 to provide the necessary energy for the endothermic steam cracking process within the tubular reactor 120. The flue gas 124 subsequently flows to the convection section 112 of the steam cracking furnace 104.

Hydrocarbon feedstock can be introduced in an inlet stream 128, which is led to convection bank 132 for superheating in the convection section 112 of the steam cracking furnace. The components and function of convection bank 132 are described in more detail below with reference FIG. 3.

Boiler feed water is introduced in stream 136 which is also heated in the convection bank 132 and transferred to a steam drum 140.

Steam from the steam drum 140 is superheated in the convection bank 132 to form a stream of superheated high pressure (VHP) steam 144. Steam 148 is then injected in the hydrocarbon stream for mixing and performing the steam cracking process in the fired tubular reactor 120. VHP steam normally has an absolute pressure in a range of 5.0-16.0 MPa.

The cracked hydrocarbon gas flows from the fired tubular reactor 120 to a transfer line heat exchanger 152, where it is cooled and discharged in stream 156 for further processing, i.e. distillation. The heat from the cracked gas recovered in the transfer line heat exchanger 152 is transferred to the steam drum 140.

FIG. 3 shows an example of a convection section 112 of a steam cracking furnace. In this example, a base case of the convection section 112 of a steam cracking furnace (104) processing 45 t/h of light hydrocarbon feedstock mixed with 18 t/h of dilution steam is presented. Hot flue gas enters the convection section at a temperature of 1173° C., where the heat is recovered by preheating the feedstock in convection bank Lower Mix Preheater (LMP) and preheating boiler feed water in convection bank economizer (ECO) and superheating the steam, generated by the transfer line heat exchanger 152, in the Upper Superheater (USH) and Lower Superheater (LSH) of the convection bank 132.

Light hydrocarbon feedstock of naphtha 128 is preheated and vaporized in Feed Pre Heater (FPH), mixed with dilution steam 148 and further heated in the Upper Mix Preheater (UMP) and LMP to 612° C. before the preheated mixed stream 160 enters the fired tubular reactor 120 in the radiant section 108 of the furnace 104. Additional heat is recovered by preheating boiler feed water 136 in the Economizer (ECO) of the convection bank 132, and superheating steam from the steam drum 140 in the USH, after which some boiler feed water is added at 164 to quench the temperature of the steam, which is then further superheated in the LSH convection bank, where superheated very high pressure steam is produced (12.0 MPa, 470° C.).

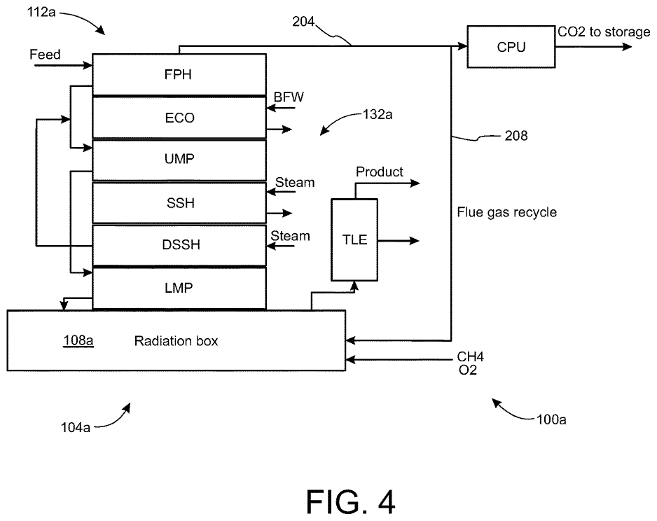

Referring now to FIG. 4, shown there and designated by the reference numeral 100a is a block diagram of a second example of a steam cracking system with a furnace having a radiant section that utilizes oxyfuel burners. The oxyfuel burner configuration means that, instead of air, oxygen is delivered with the hydrocarbon fuel (e.g., methane) to the radiant section to avoid the nitrogen and argon. In this configuration, convection section 112a is similar to a conventional air-fired furnace except configured for oxyfuel burners and fed with pure oxygen instead of air, and a portion of flue gas from the top of the convection section is recirculated to the radiant section. In this configuration, that rate at which that portion of the flue gas is recirculated is sufficient to satisfy the energy requirements of the feed preheat, economizer, mix preheating, and steam superheating functions performed in the convection section. More specifically, FIG. 4 illustrates an example of a prior art Olefins 4 furnace (e.g., if a conventional furnace were retrofitted to utilize oxyfuel burners in the radiant section).

In the example shown, system 100a is similar to system 100 in several respects. For example, furnace 104a includes a radiant section 108a and a convection section 112a, and its convection section 112a receives flue gas from radiant section 108a. Certain components of the convection bank 132a of convection section 112a differ from those of convection bank 132. For example, convection bank 132a includes a single Steam Superheater (SSH)—instead of USH and LSH—to superheat steam from the TLE, and a dilution steam superheater (DSSH) to superheat a portion of dilution steam to be added to the hydrocarbon-steam mix between the FPH and the UMP. Finally, in furnace 104a, the temperatures vary relative to those shown in FIG. 3 according to particular implementations. The heat exchangers in convection section 112a extract thermal energy from the flue gas and thereby reduces the temperature of the flue gas to a temperature at or above 120° C. before the flue gas is recirculated (referred to below as Warm Flue Gas Recirculation (FGR)).

In addition to oxyfuel burners in radiant section 108a and pure oxygen feed instead of air, system 100a includes a carbon purification unit (CPU) configured to sequester CO₂ from the flue gas. An outlet conduit 204 extends from an outlet of the convection section 112a to an inlet of the CPU, and a bypass conduit 208 extends from conduit 204 at a point upstream of the CPU to redirect a portion of the flue gas into the radiant section 108a. In this configuration, the portion of flue gas redirected from outlet conduit 204 is, once reheated in radiant section 108a, sufficient to supply the energy needs of convection section 108a to preheat the feed and feed-steam mixture as well as to superheat the steam from the TLE, and to increase the steam output by the TLE by preheating boiler feed water (BFW) in the economizer.

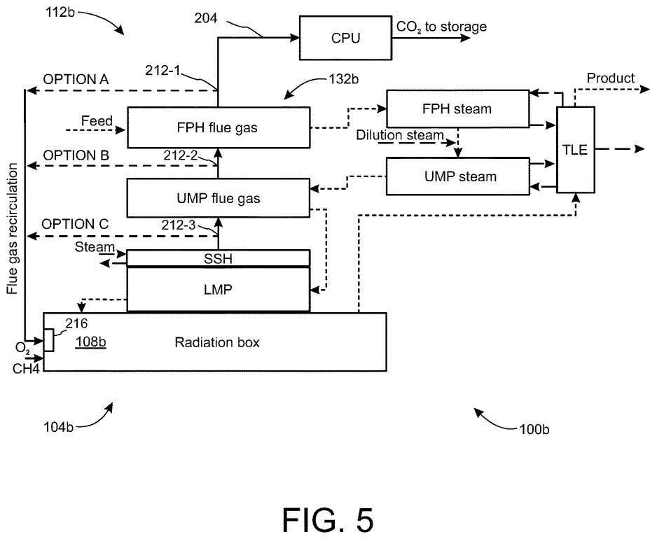

Referring now to FIG. 5, shown there and designated by the reference numeral 100b is a block diagram an example of the present steam cracking furnace systems showing three independent variations of the system. System 100b is similar to system 100a in some respects. In this configuration, convection section 112b includes a simplified convection bank 132b with a LMP, a SSH, a UMP, and a FPH; and without an ECO or a DSSH, such that the convection section reduces the temperature of flue gas by roughly an equivalent amount as convection section 112a of FIG. 4. In each of the three variations of this system, a portion of flue gas is redirected from the radiant section 108b to the convection section, but that portion of flue gas—even once reheated in the radiant section—is generally insufficient to meet the energy needs of the convection section. As such, in this system, convection section 112b is configured to (a) receive thermal energy from a source other than the flue gas; or (b) direct the feedstock (e.g., mixture of feedstock and steam) through an additional heater that receives thermal energy from a source other than the flue gas; or (c) both (a) and (b). In each of the three variations of FIG. 5 (designated as OPTION A, OPTION B, and OPTION C), convection section 112b includes a flue gas bypass (212-1, 212-2, and 212-3, respectively) to direct a portion of received flue gas to a gas inlet 216 of radiant section 108b.

In OPTION A, a portion of flue gas is directed from convection section 112b via flue gas bypass 212-1 (not via 212-2 or 212-3) to gas inlet 216 of radiant section 108b to be reheated in radiant section 108b and provide thermal energy to the heat exchangers in convection section 112b. In the configuration of OPTION A, the flue gas is removed from the convection section at a first temperature which is similar to that of the recirculated flue gas in FIG. 4; however, a smaller portion of available flue gas is removed for recirculation than in FIG. 4, such that in OPTION A of FIG. 5 the system is configured to recirculate a portion of flue gas that—even after being reheated in the radiant section—is insufficient to meet the thermal energy requirements of the convection section (i.e., feed preheating, and mix preheating, in the depicted configuration).

In particular, for the options of FIG. 5, the amount of recirculated flue gas is selected to provide sufficient thermal energy for the SSH and LMP functions (which require a temperature higher than that of the steam available from the TLE (which may, for example, be limited to providing steam at a maximum condensation temperature of 325° C.). The bypass amount sufficient to meet the requirements of the SSH and LMP will depend on the temperature of the flue gas at the point (OPTION A, OPTION B, OPTION C) at which it is removed from the convection section (which temperature will necessarily impact the amount of energy required to reheat the recirculated flue gas in the radiant section 108b).

In OPTION B, a portion of flue gas is directed from convection section 112b via flue gas bypass 212-2 (not via 212-1 or 212-3) to gas inlet 216 of radiant section 108b to be reheated in radiant section 108b and provide thermal energy to the heat exchangers in convection section 112b. In the configuration of OPTION B, the flue gas is removed from the convection section at a second temperature that is higher than the first temperature at which flue gas is removed in OPTION A—i.e., before thermal energy is removed from flue gas in the flue gas-heated FPH (“FPH flue gas”). When flue gas is removed from the convection section at this higher second temperature, even less hydrocarbon must be burned in radiant section 108b to raise the tube reactor in the radiant section to a sufficient temperature (including reheating recirculated flue gas). As a tradeoff, however, the removal of a portion of the flue gas before it enters the “FPH flue gas” means that less thermal energy is available to preheat the feedstock in FPH flue gas such that additional thermal energy must be added separately to complete the feed preheating function. As in OPTION A, in OPTION B of FIG. 5 the system is configured to recirculate a portion of flue gas that—even after being reheated in the radiant section—is insufficient to meet the thermal energy requirements of the convection section (i.e., feed preheating, and mix preheating, in the depicted configuration).

In OPTION C, a portion of flue gas is directed from convection section 112b via flue gas bypass 212-3 (not via 212-1 or 212-2) to gas inlet 216 of radiant section 108b to be reheated in radiant section 108b and provide thermal energy to the heat exchangers in convection section 112b. In the configuration of OPTION C, the flue gas is removed from the convection section at a third temperature that is higher than the second temperature at which flue gas is removed in OPTION B—i.e., before thermal energy is removed from flue gas in either of the flue gas-heated FPH (“FPH flue gas”) or the flue gas-heated UMP (“UMP flue gas”). When flue gas is removed from the convection section at this higher third temperature, less hydrocarbon than in OPTION A (slightly more than in OPTION B) must be burned to raise the tube reactor in the radiant section 108b to a sufficient temperature (including reheating recirculated flue gas). As a tradeoff, however, the removal of a portion of the flue gas before it enters the “UMP” means that: (a) less thermal energy is available to preheat the feedstock in “FPH flue gas” such that additional thermal energy must be added separately to complete the feed preheating function, and (b) less thermal energy is available to heat the feedstock-steam mixture in “UMP flue gas” such that additional thermal energy must be added to heat the mixture. As in each of OPTION A and OPTION B, in OPTION C of FIG. 5 the system is configured to recirculate a portion of flue gas that—even after being reheated in the radiant section—is insufficient to meet the thermal energy requirements of the convection section (i.e., feed preheating, and mix preheating, in the depicted configuration).

In certain configurations of each of OPTION A, OPTION B, and OPTION C, the gas bypass 212-1, 212-2, or 212-3 may be adjustable to vary the amount of flue gas that is recirculated to allow adjustment for different feedstock properties, furnace fouling, and the like.

As explained above, system 100b for each of OPTION A, OPTION B, and OPTION C requires additional thermal energy (beyond that available from flue gas) to preheat the feedstock, heat the feedstock-steam mixture, and superheat steam. That additional energy can be supplied by or derived from any of various sources, such as, for example, steam (e.g., from the TLE and/or from a feed-effluent exchanger), one or more additional heaters (e.g., electric heaters), or any of various other sources of additional thermal energy. In the depicted configuration, the feed preheat function of the “FPH flue gas” heat exchanger is supplemented by an additional (e.g., external to convection section 112b) heat exchanger (“FPH steam”) that is configured to receive steam from the TLE and transfer thermal energy from that TLE steam to the feedstock from the “FPH flue gas” heat exchanger. Additionally, in the depicted configuration, the mix preheating function of the “UMP flue gas” heat exchanger is supplemented by an additional (e.g., external to the convection section 112b) heat exchanger (“UMP steam”) that is configured to receive steam from the TLE and transfer thermal energy from that TLE steam to the feedstock-steam mixture from the “UMP flue gas” heat exchanger. As shown, in this configuration, dilution steam is mixed into the feedstock between the “FPH steam” heat exchanger and the “UMP steam” heat exchanger, such that the “UMP steam” heat exchanger begins to preheat the mixture before the partially preheated mixture is directed to the “UMP flue gas” heat exchanger in the convection section 112b. As noted above, alternative sources of thermal energy may be used in addition to or in place of the steam heat exchangers shown in FIG. 5, and/or steam may be utilized from alternative or additional sources (other than or in addition to the TLE and/or a feed-effluent exchanger).

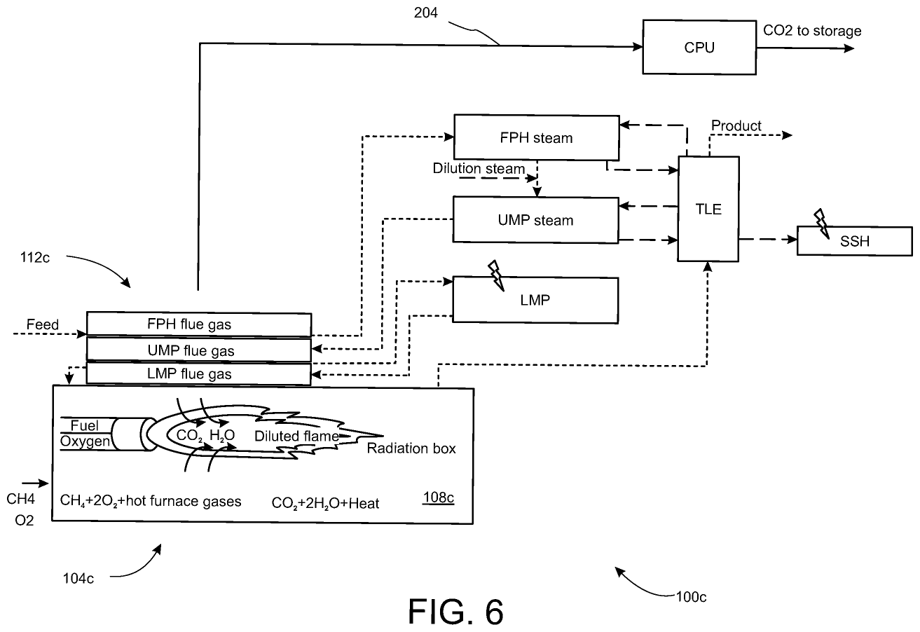

Referring now to FIG. 6, shown there and designated by the reference numeral 100c is a block diagram of a second example of the present steam cracking furnace systems for use in a steam cracking system. System 100c is similar in some respects to system 100b, with the primary exceptions that convection section 112c is further simplified by omission of an SSH from the convection bank, and radiant section 108c utilizes one or more of what are known in the art as flameless oxyfuel burners, with no flue gas being recirculated externally from convection section 112c to radiant section 108c. Such flameless oxyfuel burners may, in at least some configurations, effectively recirculate or recycle a certain portion of flue gas internally within the radiant section, such as to stabilize the burner during combustion of the fuel. The lack of external recirculation of flue gas means that even less hydrocarbon fuel (e.g., methane) needs to be burned to raise the tube reactor in the radiant section to a sufficient temperature and, as such, even less flue gas is directed to, and less thermal energy is available from flue gas in, the convection section 112c. To compensate for that relative reduction in available thermal energy in convection section 112c, system 100c also includes an LMP for which thermal energy is provided by an electric heater or electric heating elements, and an SSH for which thermal energy is provided by an electric heater or electric heating elements. In other configurations, thermal energy may be provided via any of various known sources other than electric heaters or electric heating elements (e.g., additional, localized burners).

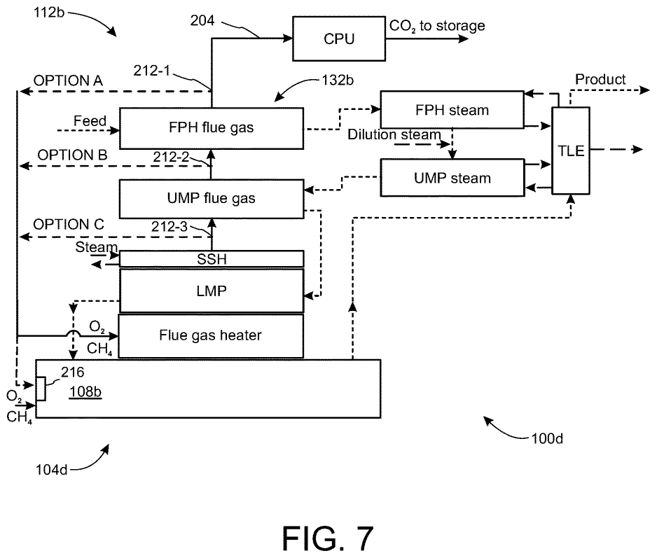

Referring now to FIG. 7, shown there is a block diagram of a further example 100d of the present steam cracking furnace systems with an oxyfuel radiant section and a supplemental oxyfuel flue gas heater. System 100d is similar to system 100b (including options for placement of a flue gas bypass), with the primary exception that system 100d includes a supplemental oxyfuel flue gas heater to add thermal energy to flue gas that is recirculated from the convection section (112b) and, through combustion of additional fuel, to generate additional flue gas to supply thermal energy to the convection section (112b). More particularly, flue gas heater receives the recirculated portion of flue gas from a flue gas bypass (212-1, 212-2, or 212-3) and burns fuel to reheat the flue gas and generate additional, hot flue gas. More particularly, in the depicted configuration, flue gas heater includes one or more oxyfuel burners to combust the hydrocarbon fuel (e.g., methane) with pure oxygen, reheating the recirculated flue gas and generating additional hot flue gas to provide thermal energy to the convection section (112b).

In some variations, a portion of the recirculated flue gas from the flue gas bypass (212-1, 212-2, or 212-3) is also directed to gas inlet 216 of radiant section 108b, as indicated by the dashed arrow in FIG. 7, such that this portion of recirculated flue gas is reheated in radiant section 108b.

In the depicted configuration, flue gas heater is disposed between radiant section 108b and convection section 112b, such that flue gas generated in radiant section 108b is conveyed to convection section 112b through flue gas heater. In other configurations, flue gas heater can be spaced from the inlet of convection section with the outlet of the flue gas heater coupled to the inlet of the convection section (112b), such that flue gas from radiant section 108b does not pass through the flue gas heater until after that flue gas has been recirculated from the convection section. Instead, the reheated and additional flue gas from the flue gas heater is conveyed to the inlet of the convection section, either (a) directly such that the reheated and additional flue gas from the flue gas heater mixes with the flue gas from the radiant section after both have entered the convection section, or (b) through a mixing chamber within which the reheated and additional flue gas from the flue gas heater mixes (or begins to mix) with the flue gas from the radiant section prior to the mixture entering the convection section.

In the depicted configuration, the additional thermal energy added to convection section by flue gas heater does not supply all of the thermal energy needs of the convection section, such that the “FPH steam” and “UMP steam” heat exchangers are still utilized to supplement the feed preheat and upper mix preheat functions of the convection section (112b); however, given similar overall system throughput, the addition of flue gas heater does reduce the amount of thermal energy input by the “FPH steam” and/or “UMP steam” heat exchangers relative to that of system 100b of FIG. 5.

In other variations of any of the disclosed systems with supplemental flue gas heaters, the supplemental flue gas heater may be sufficiently large to provide all thermal energy requirements of the convection section, such that “FPH steam” and “UMP steam” heat exchangers may be omitted entirely, for example, in a configuration similar to system 100a of FIG. 4 but with a supplemental flue gas heater and recirculated flue gas directed to the supplemental flue gas heater, the radiant section (112a), or both. In system 100a, the supplemental flue gas heater can be added between radiant section 108a and lower mix preheater (LMP) of convection section 112a such that flue gas from radiant section 108a passes through the supplemental flue gas heater before entering convection section 112a, or can be spaced from convection section 112a as described above as a variation on system 100d of FIG. 7.

### Comparative Modeling

The configurations of FIGS. 4, 5, and 6 were modeled using commercial modeling software, with a conventional (non-oxyfuel) steam-cracking system as the Base Case, the system of FIG. 4 designated as “Warm FGR”; the system of FIG. 5, OPTION A with flue gas removed from flue gas bypass 212-1 at a temperature of 150° C. designated as “150° C. FGR”; the system of FIG. 5, OPTION B with flue gas removed from flue gas bypass 212-2 at a temperature of 330° C. designated as “330° C. FGR”; the system of FIG. 5, OPTION C with flue gas removed from flue gas bypass 212-3 at a temperature of 510° C. designated as “510° C. FGR”; and the system of FIG. 6 as “Flameless OF.” All options were modeled for production of 28 tonnes per hour of olefin product, radiant section heating duty of 18.3 MW, and TLE duty of 12 MW.

Certain summary results of that modeling are shown in TABLES 1, 2, and 3 (assuming for modeling purposes 100% efficient use of steam). In these tables, components followed by the suffix “-F” (e.g., FPH-F) designate thermal energy from flue gas, components followed by the suffix “-S” (e.g., FPH-S) designate thermal energy from steam, and components preceded by the prefix “E-” (e.g., E-SSH) designate electric heating.

TABLE 1
Energy & Fuel Usage

| | | | Oxyfuel | | | | |
|---|---|---|---|---|---|---|---|
| | | Air | Warm | 150° C. | 330° C. | 510° C. | Flameless |
| Combustion: | | Base Case | FGR | FGR | FGR | FGR | OF |
| Flue Gas | ° C. | — | 150 | 150 | 330 | 510 | 1100 |
| Recirculation | | | | | | | |
| Temp | | | | | | | |
| FGR size | ton/hr | — | 38.9 | 23.9 | 20.0 | 27.0 | 0.0 |
| CH₄ usage | ton/hr | 3.40 | 3.17 | 2.50 | 2.23 | 2.27 | 1.60 |
| CH₄ usage | MW (LHV) | 47.2 | 44.0 | 34.7 | 31.0 | 31.5 | 22.2 |
| Electricity usage | MW | 0.0 | 0.0 | 0.0 | 0.0 | 0.0 | 8.6 |
| Energy usage | MW | 47.2 | 44.0 | 34.7 | 31.0 | 31.5 | 30.8 |
| O₂ usage | ton/hr | — | 13.3 | 10.5 | 9.4 | 9.5 | 6.7 |
| HHP steam make | ton/hr | 23.6 | 22.7 | 12.9 | 8.0 | 8.6 | 8.0 |
| CO₂ make | ton/hr | 9.4 | 8.7 | 6.9 | 6.1 | 6.2 | 4.4 |

TABLE 2
Efficiencies & Relative Usage

| | | Oxyfuel | | | | |
|---|---|---|---|---|---|---|
| | Air | Warm | 150° C. | 330° C. | 510° C. | Flameless |
| Combustion: | Base Case | FGR | FGR | FGR | FGR | OF |
| CH₄ usage | 100% | 92.9% | 73.5% | 65.6% | 66.8% | 47.1% |
| Energy usage | 100% | 92.9% | 73.5% | 65.6% | 66.8% | 65.2% |
| HHP steam make | 100% | 96.0% | 54.6% | 33.7% | 36.6% | 33.9% |
| Furnace Efficiency | 93.2% | 97.3% | 97.6% | 98.5% | 98.2% | 98.9% |
| CO₂ make | 100% | 92.9% | 73.5% | 65.6% | 66.6% | 47.1% |
| Feedstock flexibility | +/− | +/− | − | + | + | + |

TABLE 3
Component Duties

| | | Oxyfuel | | | | |
|---|---|---|---|---|---|---|
| | Air | Warm | 150° C. | 330° C. | 510° C. | Flameless |
| Combustion: | Base Case | FGR | FGR | FGR | FGR | OF |

Absorbed energy

| | | | | | | | |
|---|---|---|---|---|---|---|---|
| Radiation duty | MW | 18.3 | 18.3 | 18.3 | 18.3 | 18.3 | 18.3 |
| FPH - F duty | MW | 3.1 | 2.3 | 2.6 | 0.8 | 1.2 | 0.8 |
| FPH-S duty | MW | 0 | 0.0 | 0.9 | 2.7 | 2.3 | 2.6 |
| Eco duty | MW | 3.7 | 3.2 | 0.0 | 0.0 | 0.0 | 0.0 |
| UMP-F duty | MW | 2.5 | 2.5 | 2.4 | 2.3 | 0.6 | 1.1 |
| UMP-S duty | MW | 0 | 0.0 | 3.7 | 4.3 | 4.3 | 4.3 |
| DSSH | MW | 1.9 | 1.6 | 0.0 | 0.0 | 0.0 | 0.0 |
| SSH duty | MW | 4.3 | 3.7 | 2.6 | 1.6 | 1.7 | 0.0 |
| E-SSH duty | MW | 0.0 | 0.0 | 0.0 | 0.0 | 0.0 | 1.6 |
| LMP Duty | MW | 10.2 | 11.3 | 8.1 | 7.5 | 9.2 | 1.6 |
| E-LMP Duty | MW | 0.0 | 0.0 | 0.0 | 0.0 | 0.0 | 7.0 |
| Convection bank duty | MW | 25.7 | 24.6 | 15.6 | 12.2 | 12.7 | 19.1 |
| Radiation duty | MW | 18.3 | 18.3 | 18.3 | 18.3 | 18.3 | 18.3 |
| Total Absorbed energy | MW | 44.0 | 42.9 | 33.9 | 30.5 | 31.0 | 37.4 |

Energy input

| | | | | | | | |
|---|---|---|---|---|---|---|---|
| Fired duty | MW | 47.2 | 44.0 | 34.7 | 31.0 | 31.5 | 22.2 |
| Electric heating | MW | 0 | 0 | 0 | 0 | 0 | 8.6 |
| Total energy input | MW | 47.2 | 44.0 | 34.7 | 31.0 | 31.5 | 30.8 |
| Furnace Efficiency | | 93.2% | 97.3% | 97.6% | 98.5% | 98.2% | 98.9% |

As shown in TABLE 1 and TABLE 2, the Warm FGR option of FIG. 4 reduces the energy consumption of a conventional furnace, but the energy consumption of the systems of FIG. 5 and FIG. 6 is much lower than that of FIG. 4. Of the options of FIG. 5, OPTION A (150° C. FGR) was the least optimal. The lower temperature recirculation reduces the thermal energy contributed by, and reduces the temperature differential across, the steam heat exchangers (“FPH steam” and “UMP steam”). However, it is worth noting that a higher recirculation temperature did lead to non-optimal use of the thermal energy in the flue gas and, therefore, a need for an increased flue gas recirculation rate (27 ton/hr for 510° C. FGR vs. 20 ton/hr for 330° C. vs. 23.9 ton/hr for 150° C. FGR) to meet the required energy input of the LMP and the steam super heater. The highest efficiency of the three options in FIG. 5 was found for 330° C. FGR.

An additional downside of 150° C. FGR is that the feedstock flexibility will decrease due to the variables that must be balanced with relatively more thermal energy being available in the flue gas within the “FPH flue gas” heat exchanger. In particular, the rate of flue gas recirculation must be small enough that the feed preheat does not fully evaporate before the mixing point (at which steam is added to the feedstock) but large enough that the desired cross over temperature can be obtained.

The Flameless OF configuration of FIG. 6 requires a much-lower methane usage and thus produces much less CO₂. However, the total amount of energy used by the Flameless OF configuration is similar to the total energy usage of the 330° C. FGR configuration (OPTION B) of FIG. 5. The Flameless OF configuration is expected to still be more advantageous from a cost perspective because the Flameless OF configuration will not require external recirculation of flue gas and therefore does not require bypass/recirculation ducting or blowers.

Additional details about various components of steam cracking plants and processes can be found in: (1) International Patent Application Publication No. WO2020/150244 and (2) U.S. Pat. No. 11,046,893; each of which is incorporated by reference in its entirety.

Additional details about various components of syngas synthesis plants and processes can be found in International Patent Application Publication No. WO2020/150247, which is incorporated by reference in its entirety.

The above specification and examples provide a complete description of the structure and use of exemplary embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the present devices are not intended to be limited to the particular forms disclosed. Rather, they include all modifications and alternatives falling within the scope of the claims, and embodiments other than the one shown may include some or all of the features of the depicted embodiment. For example, components may be combined as a unitary structure, and/or connections may be substituted. Further, where appropriate, aspects of any of the examples described above may be combined with aspects of any of the other examples described to form further examples having comparable or different properties and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A furnace for a chemical-production process, the furnace comprising:
a radiant housing defining a radiant section with a gas inlet and a flue gas outlet;
one or more oxyfuel burners disposed in the radiant section;
a tube reactor disposed in the radiant section;
a convection section with a convection inlet, a convection outlet, a convection channel extending from the convection inlet to the convection outlet, and a flue gas bypass disposed between the convection inlet and the convection outlet, where:
the convection inlet is coupled to the flue gas outlet of the radiant section to receive flue gas from the radiant section; and
the flue gas bypass is configured to direct a portion of received flue gas to one of:
(i) the gas inlet of the radiant section; or
(ii) a heater gas inlet of an oxyfuel flue gas heater that is configured to re-heat recirculated flue gas and convey the reheated flue gas to the convection inlet; or
(iii) both (i) and (ii);
where the convection section includes at least one heat exchanger disposed in the convection channel and configured to transfer thermal energy from the received flue gas to a mixture of steam and hydrocarbon feedstock; and
where the convection section is configured to:
(a) receive thermal energy from a source other than the received flue gas; or
(b) direct the mixture of steam and hydrocarbon through an additional heater that receives thermal energy from a source other than the received flue gas; or
(c) both (a) and (b).

2. The furnace of claim 1, where the at least one heat exchanger comprises a lower mix preheater (LMP).

3. The furnace of claim 1, where the at least one heat exchanger comprises a steam superheater (SSH) configured to transfer thermal energy from the received flue gas to steam.

4. The furnace of claim 1, where the at least one heat exchanger comprises an upper mix preheater (UMP) configured to transfer thermal energy from the received flue gas to the mixture of steam and hydrocarbon feedstock.

5. The furnace of claim 1, where the at least one heat exchanger comprises a feed preheater (FPH) configured to transfer thermal energy from the received flue gas to a hydrocarbon feedstock.

6. The furnace of claim 4, where the flue gas bypass is disposed between the LMP and the UMP.

7. The furnace of claim 5, where the flue gas bypass is disposed between the UMP and the FPH.

8. The furnace of claim 5, where the flue gas bypass is disposed between the FPH and the convection outlet.

9. A steam-cracking system comprising:
a furnace of claim 1, where the radiant section is configured to heat a mixture of steam and hydrocarbon feedstock to a cracking-reaction temperature;
a transfer line exchanger TLE coupled to an outlet of the tube reactor and configured to quench the heated mixture to a temperature below the cracking-reaction temperature;
a UMP steam heat exchanger coupled to the TLE and configured to:
receive TLE steam from the TLE;
receive a mixture of steam and hydrocarbon feedstock from one of the one or more heat exchangers in the convection section;
transfer thermal energy from the TLE steam to the mixture;
return the mixture to the furnace; and
and return the TLE steam to the TLE.

10. The steam-cracking system of claim 9, further comprising:
a MPH steam heat exchanger coupled to the TLE and configured to receive TLE steam from the TLE, transfer thermal energy from the TLE steam to the mixture of steam and hydrocarbon feedstock, and return the TLE steam to the TLE; and
a conduit coupled to the MPH steam heat exchanger and the UMP steam heat exchanger, the conduit configured to receive steam and mix the received steam with the hydrocarbon feedstock.

11. The steam-cracking system of claim 9, further comprising a carbon purification unit (CPU) configured to isolate CO₂ from the flue gas.

12. A chemical-production system comprising:
a furnace comprising:
a radiant housing defining a radiant section with a gas inlet and a flue gas outlet;
one or more oxyfuel burners disposed in the radiant section;
a tube reactor disposed in the radiant section;
a convection section with a convection inlet, a convection outlet, and a convection channel extending from the convection inlet to the convection outlet, where the convection inlet is coupled to the flue gas outlet of the radiant section to receive flue gas from the radiant section;
where the convection section includes one or more heat exchangers disposed in the convection channel and configured to transfer thermal energy from the received flue gas to a hydrocarbon feedstock;
where the convection section is configured to direct the hydrocarbon feedstock through an additional heater that receives thermal energy from a source other than the received flue gas; and
where the radiant section is configured to heat the hydrocarbon feedstock to a reaction temperature;
a carbon purification unit (CPU) coupled to the convection outlet, the CPU configured to isolate CO₂ from the flue gas; and
where the system is configured to direct substantially all flue gas received by the convection section to the CPU.

13. The system of claim 12, where the radiant section is configured to heat a mixture of steam and the hydrocarbon feedstock to the reaction temperature, the system further comprising:
a transfer line exchanger TLE coupled to an outlet of the tube reactor and configured to quench the heated mixture to a temperature below the cracking-reaction temperature;
a UMP steam heat exchanger coupled to the TLE and configured to:
receive TLE steam from the TLE;
receive a mixture of steam and hydrocarbon feedstock from one of the one or more heat exchangers in the convection section;
transfer thermal energy from the TLE steam to the mixture;
return the mixture to the furnace; and
and return the TLE steam to the TLE.

14. The system of claim 13, further comprising:
a MPH steam heat exchanger coupled to the TLE and configured to:
receive TLE steam from the TLE;
receive a hydrocarbon feedstock from one of the one or more heat exchangers in the convection section;
transfer thermal energy from the TLE steam to the mixture of steam and hydrocarbon feedstock;
return the mixture of steam and hydrocarbon feedstock to the furnace; and
return the TLE steam to the TLE; and
a conduit coupled to the MPH steam heat exchanger and the UMP steam heat exchanger,
the conduit configured to:
receive the hydrocarbon feedstock from the MPH;
receive steam and mix the steam into the hydrocarbon feedstock; and
direct the mixture of steam and hydrocarbon feedstock to the UMP steam heat exchanger.

15. The system of claim 13, where the system is configured to produce an olefin product and for each ton of the olefin product that is produced, to consume fewer than 12 gigajoules (GJ) of energy and generate fewer than 700 kilograms (kg) of carbon dioxide (CO₂).
